(19) United States
(12) Patent Application Publication
(10) Pub. No.: US 2010/0192588 A1
(43) Pub. Date: Aug. 5, 2010

(54) METHOD FOR THE PROVISION OF A COOLING-AIR OPENING IN A WALL OF A GAS-TURBINE COMBUSTION CHAMBER AS WELL AS A COMBUSTION-CHAMBER WALL PRODUCED IN ACCORDANCE WITH THIS METHOD

(75) Inventor: Miklos GERENDAS, Am Mellensee (DE)

Correspondence Address: SHUTTLEWORTH & INGERSOLL, P.L.C., 115 3RD STREET SE, SUITE 500, P.O. BOX 2107, CEDAR RAPIDS, IA, 52406, US

(73) Assignee: ROLLS-ROYCE DEUTSCHLAND LTD & CO KG, Blankenfelde-Mahlow (DE)

(21) Appl. No.: 12/697,838

(22) Filed: Feb. 1, 2010

(30) Foreign Application Priority Data
Feb. 3, 2009 (DE) 10 2009 007 164.4

(51) Int. Cl. F02C 3/14

(52) U.S. Cl. 60/752

(57) ABSTRACT

A cooling-air opening in produced in a wall (6) of a gas-turbine combustion chamber using a laser beam. In a first operation, a recess (10c) with a first, larger cross-section is produced from the hot gas side in a partial area of the wall (6) at a shallow angle to the surface. In at least one subsequent operation, a recess (10b, 10a) with a second, smaller cross-section is produced through the entire material of the wall (6) at a shallow angle to the surface while deepening a partial area of the previous recess (10c). A step (12), which is produced between the two recesses in the two operations, is larger than a median coating thickness of a subsequently applied ceramic thermal barrier coating (14).

This application claims priority to German Patent Application DE 10 2009 007 164.4 filed Feb. 3, 2009, the entirety of which is incorporated by reference herein.

Gas-turbine combustion chambers are characterized by high environmental compatibility. A condition therefore is efficient fuel utilization and, in connection therewith, low pollutant emission.

For this, the process air furnished by a compressor of the gas turbine must be supplied to the maximum extent possible to the actual combustion process. Consequently, the air quantity used for cooling purposes should be as small as possible, as compared to the entire process air.

For cooling a combustion-chamber wall, effusion cooling has proven to be particularly effective. With this type of cooling, the combustion-chamber wall is provided with a multitude of cooling-air openings through which the process air forming the cooling air is introduced into the combustion chamber to produce a cooling-air film on the surface of the combustion-chamber wall. However, with the cumulated cross-sectional area of cooling-air influx being pre-defined by the design, the size of the individual cooling-air openings or their diameter or cross-section, respectively, is very small.

For the production of the cooling-air openings it is known to use a laser drilling process. In the process, the holes are produced at a relatively shallow angle in the direction of the general combustion-chamber flow to provide for optimum formation of the cooling film on the hot side of the combustion-chamber wall. The cooling-air openings are here inclined at an angle between 20° and 45° relative to the combustion-chamber wall. This has been presented, for example, in specification U.S. Pat. No. 5,181,379.

A variant of a combustion-chamber wall with cooling-air openings is known from specification US 2008/0271457 A1. Here, the cross-section increases continuously to the hot gas side of the combustion-chamber wall.

A combustion-chamber wall with a cooling-air opening widening only on one section near the hot gas side is published in specification EP 0 985 802. For the cooling of turbine blades, it is known to provide a stepwise changing cross-section of the cooling-air openings, as shown in specification EP 0 227 582 B1, for example.

The increase in cross-section leads to a higher film cooling efficiency as the air exiting on the hot side, on account of the increase in cross-section, has lower exit velocity and, therefore, attaches to the wall to be cooled rather than penetrating into the hot gas flow.

Such cross-sectionally varying cooling-air openings are produced by spark erosion processes, with the electrode of the spark erosion machine representing the inner contour of the cooling-air openings. Such spark erosion processes are very cost-intensive and require high time investment, making them unsuitable for use with the multitude of cooling-air openings in a combustion-chamber wall. Accordingly, such application is limited essentially to turbine components.

Suitable for use in combustion-chamber production is a percussion-type or a trepanning-type laser drilling process. Both processes produce essentially circular holes.

Combustion chambers are usually provided with a ceramic thermal barrier coating. If this thermal barrier coating is applied prior to drilling the cooling-air openings, the openings have to be drilled through the ceramic thermal barrier coating, which drastically increases machining times, and thus costs, and affects the bond between the metallic combustion-chamber wall and the ceramic thermal barrier coating. If the ceramic thermal barrier coating is applied after drilling the cooling-air holes, the latter will partly be closed again. Accordingly, one could drill the cooling-air holes correspondingly larger and tolerate the variability of the cooling-air flow, or the cooling-air holes must be re-cleaned after applying the ceramic thermal barrier coating, which, due to the multitude of cooling-air holes in a combustion chamber, will again incur considerable costs and may also affect the bond of the ceramic thermal barrier coating on the metallic combustion-chamber wall.

In a broad aspect, the present invention provides a method for the provision of a cooling-air opening in a wall of a gas-turbine combustion chamber as well as a combustion-chamber wall machined to this method, which enables cost-effective and operationally safe production and provision of cooling-air openings and of the thermal barrier coating.

According to the present invention, the method for the production of a cooling-air opening in a wall of a gas-turbine combustion chamber with a laser beam is performed such that, in a first operation, a recess with a first, larger cross-section is produced from the hot gas side in a partial area of the wall at a shallow angle to the surface and, in at least one subsequent operation, a recess with a second, smaller cross-section is produced through the entire material of the wall at a shallow angle to the surface while deepening a partial area of the previous recess, and a step, which is produced between the two recesses in the two operations, is larger than a median coating thickness of a subsequently applied ceramic thermal barrier coating.

Useful according to the present invention is percussion drilling from the hot gas side since this process produces the full hole diameter in one shot and removes only a few tenths of a millimeter rather than penetrating through the entire wall thickness. Therefore, the present invention provides that, by use of a laser beam, a cooling-air opening is produced whose cross-section increases from the cooling-air entry to the cooling-air exit and which is therefore characterized by optimum aerodynamic properties.

Production of the cooling-air opening in accordance with the present invention by using a laser beam in the percussion-type drilling process is highly economical with the great number of cooling-air openings required.

According to the present invention, there are two ways to produce a herein proposed recess by a laser percussion drilling process. Firstly, a recess with a smaller diameter can initially be produced which preferably has circular or elliptical cross-section and penetrates through the entire material of the combustion-chamber wall. In a subsequent operation, the cooling-air opening is then widened in that, in a further laser drilling section, a recess with larger diameter, which also can be either circular or elliptical, is produced independently of the cross-section of the first recess, penetrating into only a part of the wall, but not through the entire wall thickness. According to this method, still further hole sections can be produced. Thus, a diameter increase is produced to that side of the combustion-chamber wall which is exposed to the flame or the hot gas, respectively. Alternatively, a recess with the largest circular or elliptical cross-section and a small penetration depth can first be produced from the hot gas side. Then, the wall stock is further penetrated with recesses having smaller circular or elliptical cross-section. In this hole section or in one of the further hole sections, the wall will then be fully penetrated.

According to the present invention, it is particularly favorable if the hot gas-facing side of the wall is provided with a thermal barrier coating (ceramic thermal barrier coating). According to the present invention, such a thermal barrier coating is produced by spray application of ceramic material after drilling the cooling-air openings.

In order to avoid ingress of ceramic material into the cooling-air opening, it is particularly advantageous if, on the one hand, the cooling-air opening is obliquely arranged, which also provides for a better cooling airflow, and, on the other hand, it is provided that the spray direction for application of ceramic material is inclined or tilted by an angular amount from the perpendicular to the surface of the combustion-chamber wall. It is thus avoided that the ceramic material is directly sprayed into the cooling-air opening, with this material rather being applied to a wall area of the recess which is also thermally insulated. Favorably, the spray direction for application of ceramic material is selected such that it is essentially vertical to the center axis of the final recess, which features the greatest diameter. A cross-sectionally widening cooling-air opening, as provided by the present invention, increases the effectiveness of film cooling by reducing outflow velocity.

According to the present invention, it can further be advantageous to additionally incline the individual axes of the individual recesses relative to the surface of the combustion-chamber wall at an angle which becomes shallower the larger the diameter of the individual recesses is. Here, the cooling-air opening is cross-sectionally stepped such that the respectively next larger diameter of the stepwise increasing cooling-air opening completely determines the rim of the hole and no notch is produced in the cross-section by the smaller diameter of the preceding, smaller and steeper recess.

According to the present invention, it is particularly favorable if several, subsequent recesses are produced, thereby providing a three-step configuration, for example.

Within the framework of the present invention, the following diameters are for example preferably provided: The smallest diameter of the initially produced recess ranges for example from 0.3 to 0.9 mm. This recess has, for example, an inclination to the surface of the combustion-chamber wall of 20° to 45°. The exit of the flame-facing side of the recess with larger diameter has, for example, an inclination of 5° to 25° to the surface of the combustion-chamber wall.

In an alternative or preferred embodiment, the first recess features a diameter of 0.5 to 0.7 mm and an inclination of 25° to 35°, while the flame-facing recess is inclined to the surface of the combustion-chamber wall at an angle of 10° to 20°.

In development of the present invention, it is further advantageous if the first recess is arranged at an inclination of 30° to the surface of the combustion-chamber wall, while the hot gas-facing recess is inclined at an angle of 15° to the surface of the combustion-chamber wall.

Since, according to the present invention, the individual recesses of the cooling-air opening are produced stepwise one after the other, they can be provided with different cross-sectional areas and different cross-sectional shapes. Each of the recesses can accordingly have different cross-section, for example a circular or an elliptical one. According to the present invention, it is therefore possible to produce the cooling-air openings rapidly and cost-effectively, for example by use of a laser process, in particular a laser percussion drilling process.

According to the present invention, the step height at the exit of the cooling-air opening to the hot gas side can be selected larger than the thickness of the ceramic thermal barrier coating, so that only a very small step is left upon application of the ceramic thermal barrier coating and no blockage of the cooling-air opening occurs. Therefore, the cooling-airflow rate through the cooling-air opening is not reduced. According to the present invention, it is therefore not necessary to perform any rework, for example cleaning the cooling-air openings by water jet or laser beam. Also, this results in substantial time saving associated with cost saving. Rather, the cooling air is enabled to very well follow the hot gas-facing final recess and attach to the wall of the combustion chamber, thereby improving the efficiency of film cooling. Cooling efficiency is further enhanced by a deviation of the cross-section from circularity, thereby providing a laterally wider and—as far as its height is concerned—smaller cross-sectional area.

In the following, the present invention is more fully described in light of the accompanying drawings, showing a preferred embodiment. In the drawings,

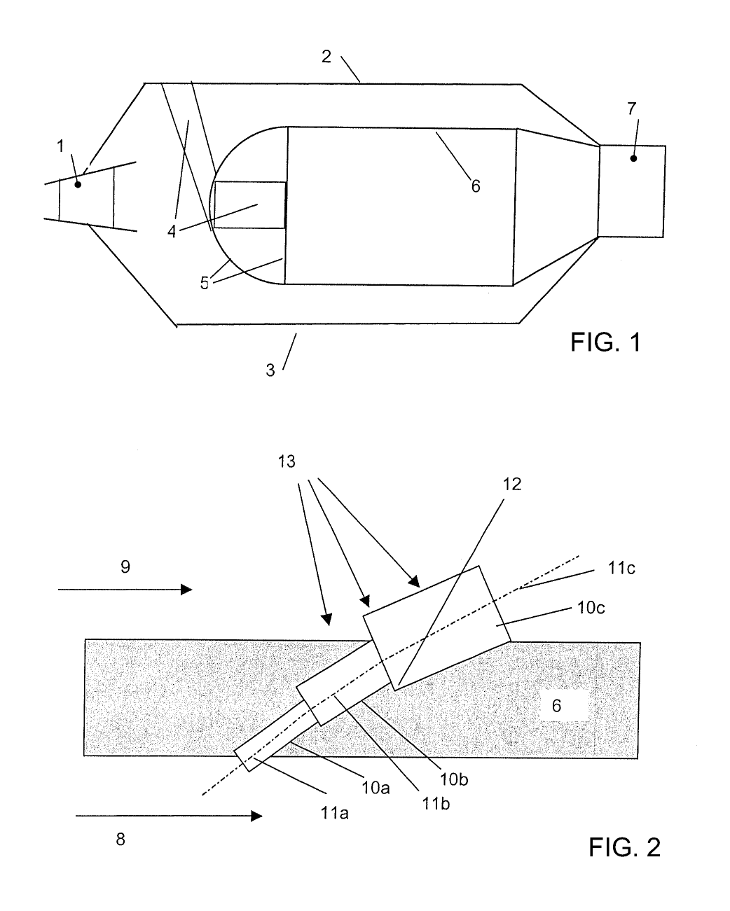

FIG. 1 is a schematic lateral view of a gas-turbine combustion chamber in accordance with the present invention,

FIG. 2 is a simplified sectional view of a portion of a combustion-chamber wall with a cooling-air opening in accordance with the present invention,

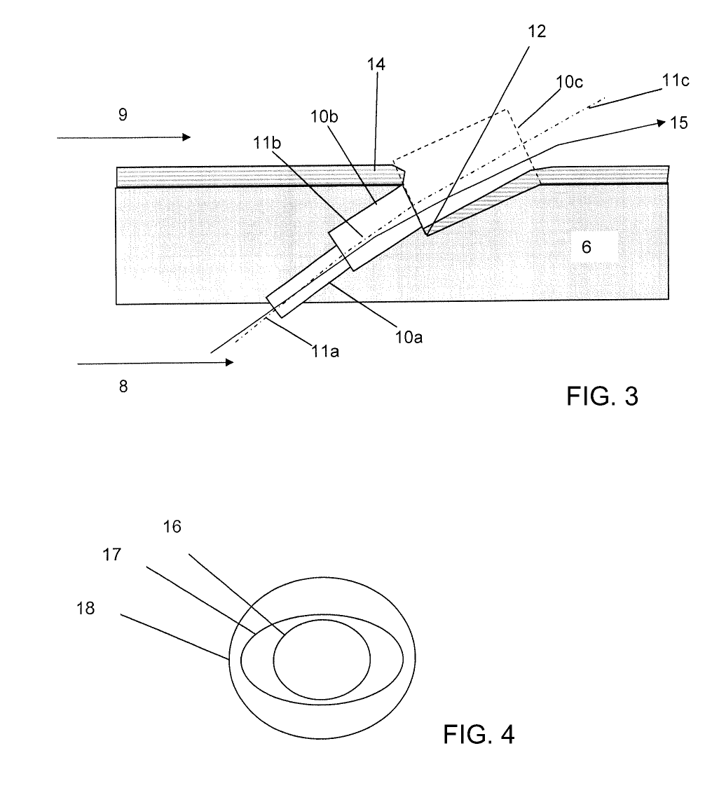

FIG. 3 is a representation, analogically to FIG. 2, upon applying a ceramic thermal barrier coating, and

FIG. 4 shows a schematic allocation of the cross-sectional shapes.

FIG. 1 shows, in schematic representation, compressor exit vanes 1 through which compressor air is fed into a combustion-chamber casing. This includes a combustion-chamber outer casing 2 and a combustion-chamber inner casing 3. Further provided is a burner with arm and head (reference numeral 4). Reference numeral 5 shows, in schematic representation, a combustion-chamber head followed by a combustion-chamber wall 6. Reference numeral 7 schematically represents turbine entry vanes.

FIGS. 2 and 3 show a sectional view through a partial area of a combustion-chamber wall 6. A flow of cooling air 8 passes on the lower side, while a hot gas flow 9 is present on the upper side in the combustion chamber.

As schematically represented in FIG. 2, a first recess 10a with essentially circular diameter and with its center axis 11a being angularly inclined is initially produced in the combustion-chamber wall 6. Subsequently, a second recess 10b is produced from that side of the combustion-chamber wall 6 which is wetted by the hot gas flow 9. The axis 11b of the second recess 10b is angularly inclined to the axis 11a of the first recess 10a. In a further operation, a third recess 10c is produced, also using a laser drilling process, whose axis 11c is inclined to the axis 11b of the recess 10b. Recess 10c has a larger cross-section than recess 10b. Consequently, a step 12 is produced between recess 10b and recess 10c.

According to the present invention, the individual recesses 10 can also be produced in the sequence 10c, 10b and finally 10a, i.e. starting with the largest cross-section and small penetration depth and proceeding towards the smallest cross-section with penetration of the combustion-chamber wall.

Reference numeral 13 indicates, in simplified representation, the spray direction for application of the ceramic thermal barrier coating. This is arranged essentially perpendicular to the axis 11c of the outer recess 10c.

FIG. 3 shows, analogically to FIG. 2, a view of the finished state with thermal barrier coating 14 applied. As can be seen, a median thickness of the thermal barrier coating at the step between recess 10c and 10b is less than or equal to the height of the step between recess 10c and 10b so as not to interfere with the flow of air through the recesses. Also shown in FIG. 3 is the flow direction 15 of the cooling air. It is redirected by the respective inclination of the axes 11a, 11b and 11c to the surface of the combustion-chamber wall 6, thereby providing for better attachment of the cooling air on the surface of the combustion-chamber wall 6.

FIG. 4 shows, by way of example, the sequence of cross-sectional sizes and cross-sectional shapes. Reference numeral 16, for example, shows an essentially circular cross-section of recess 10a followed by an essentially elliptical recess 10b which again is followed by an essentially circular cross-sectional shape of the recess 10c.

### LIST OF REFERENCE NUMERALS

1 Compressor exit vanes
2 Combustion-chamber outer casing
3 Combustion-chamber inner casing
4 Burner with arm and head
5 Combustion-chamber head
6 Combustion-chamber wall
7 Turbine entry vanes
8 Cooling-air supply
9 Hot gas flow in the combustion chamber
10 Cooling-air opening with recesses a, b and c
11 Axes of individual recesses (a, b, c)
12 Step between the last two recesses
13 Spray direction for application of thermal barrier coating
14 Thermal barrier coating
15 Flow direction of cooling air
16 Exemplary cross-section of cooling-air supply 10a
17 Exemplary cross-section of mean cooling-opening recess 10b
18 Exemplary exit cross-section of cooling opening 10c

What is claimed is:

1. A method for producing a cooling-air opening in a wall of a gas-turbine combustion chamber, comprising:
in a first operation, producing a first recess with a laser from a hot gas side of the combustion chamber wall, the first recess having a first cross-section in a partial area of the wall at a shallow angle to a surface of the wall;
in at least one subsequent operation, producing a second recess with a laser, the second recess having a second cross-section smaller than the first cross-section through an entire thickness of the wall at a shallow angle to the surface while deepening a partial area of the first recess; and
producing a step between the first and second recesses in the two operations that is larger than a median coating thickness of a subsequently applied ceramic thermal barrier coating.

2. A method for producing a cooling-air opening in a wall of a gas-turbine combustion chamber, comprising:
in a first operation, producing a first recess with a laser from a hot gas side of the combustion chamber wall through an entire thickness of the wall, the recess having a first cross-section at a shallow angle to a surface of the wall;
in at least one subsequent operation, producing a second recess with a laser through a partial area of the wall, the recess having a second cross-section larger than the first cross-section at a shallow angle to the surface while widening a partial area of the first recess, and
producing a step between the first and second recesses in the two operations that is larger than a median coating thickness of a subsequently applied ceramic thermal barrier coating.

3. The method of claim 1, wherein the recesses have essentially circular cross-sections.

4. The method of claim 1, wherein the recesses have essentially elliptical cross-sections.

7. The method of claim 1, wherein center axes of the respective recesses are angularly arranged relative to each other.

8. The method of claim 7, wherein the center axes of the respective recesses have an angle relative to the hot-gas side that increases with decreasing cross-section.

9. The method of claim 1, and further comprising forming more than two interconnected recesses.

10. The method of claim 1, wherein a spray direction for application of the thermal barrier coating is essentially vertical to a center axis of the first recess.

11. The method of claim 2, wherein the recesses have essentially circular cross-sections.

12. The method of claim 2, wherein the recesses have essentially elliptical cross-sections.

13. The method of claim 2, wherein center axes of the respective recesses are angularly arranged relative to each other.

14. The method of claim 13, wherein the center axes of the respective recesses have an angle relative to the hot-gas side that increases with decreasing cross-section.

15. The method of claim 2, and further comprising forming more than two interconnected recesses.

16. The method of claim 2, wherein a spray direction for application of the thermal barrier coating is essentially vertical to a center axis of the first recess.

17. A combustion chamber wall of a gas turbine, comprising:
at least one cooling-air opening having a cross-section increasing stepwise from a side of the wall to which cooling air is applied, to a side of the wall which is wetted by a hot gas flow, the cooling-air opening being formed of several recesses separately produced by a laser drilling process, with a last hot-gas side step between the recesses being partly filled by a subsequently applied ceramic thermal barrier coating.
